(19) United States
(12) Patent Application Publication
(10) Pub. No.: US 2013/0297503 A1
(43) Pub. Date: Nov. 7, 2013

(54) SYSTEMS AND METHODS FOR SECURE DIGITAL IDENTIFICATION CARD PROCESSING

(71) Applicant: Jar ID, LLC, Neptune, NJ (US)

(72) Inventor: James McGowan, Toms River, NJ (US)

(21) Appl. No.: 13/830,353

(22) Filed: Mar. 14, 2013

Related U.S. Application Data
(60) Provisional application No. 61/618,091, filed on Mar. 30, 2012.

(51) Int. Cl. G06Q 20/40

(52) U.S. Cl. CPC G06Q 20/4016
USPC 705/41

(57) ABSTRACT

A system and method for verifying a transaction includes verifying a transaction, by a processing device, includes receiving a verification code generated by a verification device based in part on a current count from a counter configured to count the passage of defined intervals of time, wherein the counter is started at a randomly generated start count. The method also includes verifying the verification code based in part on a current count calculated independently from the counter. On a condition the verification code is verified, approval for the transaction is transmitted. The verification device includes a counter configured to count the passage of defined intervals of time. The processing device includes a second circuit configured to electronically receive and verify the verification code based, in part, on the current count, wherein the second circuit calculates the current count independently of the counter.

### REFERENCE TO RELATED APPLICATIONS

This application is a non-provisional application claiming priority to U.S. Provisional Patent Application Serial No. 61/618,091 filed Mar. 30, 2012, which is hereby incorporated by reference as if fully disclosed herein.

### FIELD OF THE DISCLOSURE

The present disclosure relates to secure identification card processing and authentication methods and systems.

### BACKGROUND OF THE INVENTION

Credit card fraud is a wide-ranging term for theft and fraud committed using a credit card or any similar payment mechanism as a fraudulent source of funds in a transaction. The purpose may be to obtain goods without paying, or to obtain unauthorized funds from an account. Credit card fraud is also closely related to identity theft generally. According to the Federal Trade Commission, credit card fraud accounted for more than 13% of all identity theft claims, the second largest percentage after government documents and benefits fraud.

The cost of card fraud can be as high as 7 cents per 100 dollars' worth of transactions. Considering the high volume of credit and debit card transactions this translates to billions of dollars. Merchants and the financial institutions bear this loss, including the value of any goods or services sold, and any associated fees. These losses incline merchants to be cautious and often they ban legitimate transactions and lose potential revenues. Online merchants can choose to apply for additional services that credit card companies offer, but these programs often increase the complexity of transactions for consumers.

Additionally, government issued identification cards and other important documents are also at risk. Therefore, a need exists to provide additional security to identification cards.

### SUMMARY

Various implementations of devices, systems, and methods are described in this disclosure. In one implementation a transaction card includes a verification code display, a photovoltaic cell, and an integrated circuit. The integrated circuit includes a stored charge device configured to be replenished by the photovoltaic cell, a multi-bit counter configured to count the passage of defined intervals of time, the counter powered from the source charge, a programmable memory for storing a plurality of codes, a mathematics module configured to execute programming instructions to generate a verification code based on a current count from the counter and at least one of the plurality of codes stored in the programmable memory, and a display driver electrically coupled with the display, the display driver configured to cause the verification code to be output to the display. The programmable memory, mathematics module, display driver, and display are powered from the photovoltaic cell.

A system for verifying a transaction includes a verification device and a processing device. The verification device includes a counter configured to count the passage of defined intervals of time, wherein the first counter is started at a randomly generated start count and a first circuit configured to generate a verification code based in part on a current count of the first counter. The processing device includes a second circuit configured to electronically receive and verify the verification code based, in part, on the current count, wherein the second circuit calculates the current count independently of the counter.

A method for verifying a transaction includes receiving a verification code generated based in part on a current count from a counter configured to count the passage of defined intervals of time, wherein the counter is started at a randomly generated start count. The method also includes verifying the verification code based in part on a current count calculated independently from the counter. On a condition the verification code is verified, approval for the transaction is transmitted.

### BRIEF DESCRIPTION OF THE DRAWINGS

Embodiments will be described with reference to the following drawing figures, in which like numerals represent like items throughout the figures, and in which:

FIG. 1 is a diagram of the front of an example digital identification (ID) card;

FIG. 2 is a diagram of the back of an example digital ID card;

FIG. 3 is a diagram of internal circuitry of an example digital ID card;

FIG. 4 is a block diagram showing a circuit of an example digital ID card;

FIG. 5 is a system diagram showing an example digital ID card system;

FIG. 6 is a flow chart showing an example process for verifying a transaction with a digital ID card;

FIG. 7 is a flow chart showing a process for verifying the verification code; and

FIG. 8 is a block diagram of an example electronic device.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used in this document, a statement that a device or system is “in electronic communication with” another device or system means that devices or systems are configured to send data, commands and/or queries to each other via a communications network. The network may be a wired or wireless network such as a local area network, a wide area network, an intranet, the Internet or another network.

The term “data” may refer to physical signals that indicate or include information. A “data bit” may refer to a single unit of data.

Although shown and described in the figures and this detailed description as a credit card, the scenarios described in this document are not limited in this regard. Other scenarios include other financial transaction cards such as debit cards, government documents, such as passports and social security cards, employer issued identification cards, school issued identification cards, and any other card based identification card where secure authentication is desired.

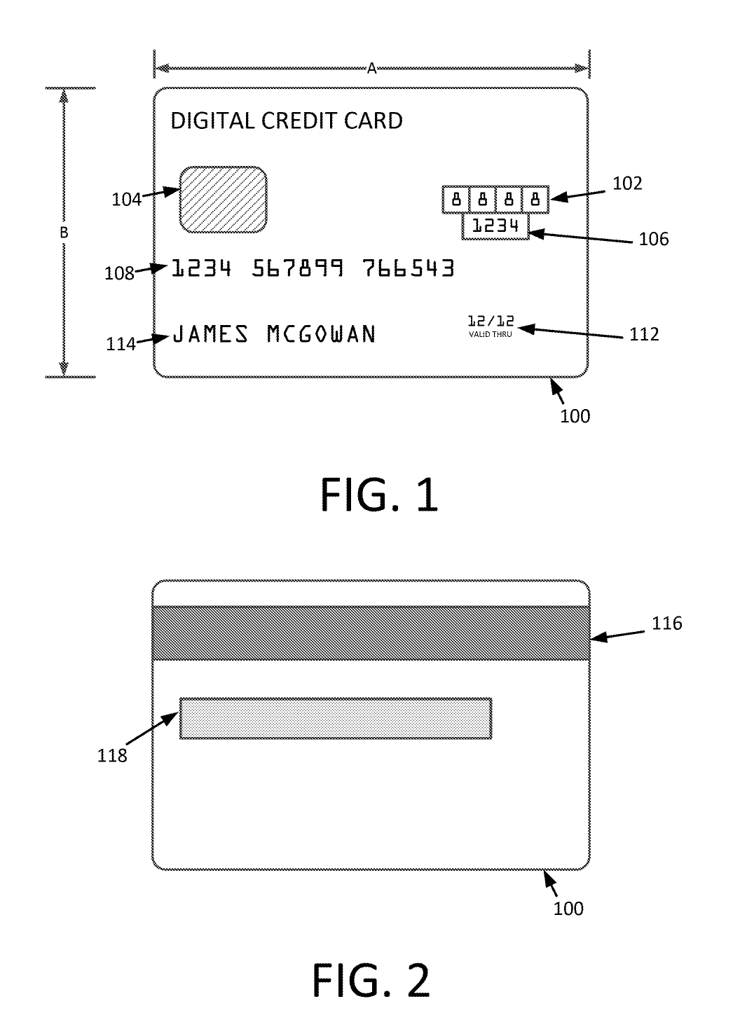

Referring to FIG. 1, a scenario for a digital identification card is shown. As disclosed in this document, a digital identification (ID) card 100 may include a display 102 on its face. Although FIG. 1 shows four (4) digits, one of skill in the art will recognize that any number of digits may be displayed. Three (3) or four (4) digit displays are typical. A power source such as a photovoltaic (e.g. solar) cell 104 used to power the display 102 can also be imbedded in the card. This display 102 will show a new, seemingly random code, on a programmable interval. Details on the generation of the random code as provided below. The ID card 100 may also include [[an]] a static code 106, a card number 108, an expiration date 112, and a name location 114. Static code 106 may be printed on molded, or otherwise formed in, the card or it may be randomly or-pseudorandomly generated when the card is manufactured, prepared, activated and/or reset. Additionally, the dimensions, A×B of the card may vary depending the type of card used. For example, since conventional credit cards have dimensions of 3⅜″×2⅛″ the digital ID card can be manufactured to those dimensions. Thickness may also vary. In the example of a credit card, a thickness of about 1/32″ may be expected.

The display 102 can be made from any suitable material such as one resembling a thin sheet of plastic. The solar cell 104 can also be thin and flexible and about the same thickness as a standard credit card, or thinner. Thus, the ID card 100 can have approximately the same size and flexibility as a conventional credit card. Referring now to FIG. 2, the reverse side of digital ID card 100 is shown. In the scenario shown in FIG. 2, magnetic strip 114 is included for encoding data on the card. In addition, or alternatively, the card may include a memory device such as a radio frequency identification (RFID) tag for storing data on the card. Alternatively or additionally, optically scanned one or two dimensional codes may also be included on the reverse side of digital ID card 100. Also included is a signature or marking strip 116.

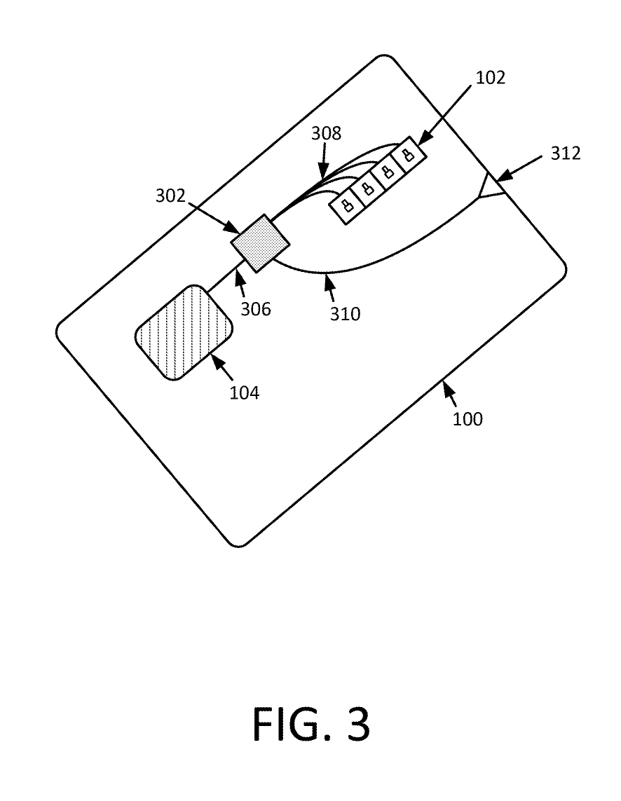

Referring now to FIG. 3, a diagram of the electronic components of a digital ID card 100 is shown with a top layer plastic film removed. Digital ID card 100 may contain a counter circuit 302. The photovoltaic cell 104 is connected to the counter circuit 302 through main power bus 306. Display bus 308 provides power and data connectivity to display 102. The ID card can store enough power to run the counter for an extended period without recharging. When the photovoltaic cell 104 activates, the stored charge in the circuit 302 would be replenished. In one scenario, the counter is only powered by the stored charge. All other components (i.e. the display and non-counter functions of the counter circuit) will only operate while the photovoltaic cell is exposed to sufficient light.

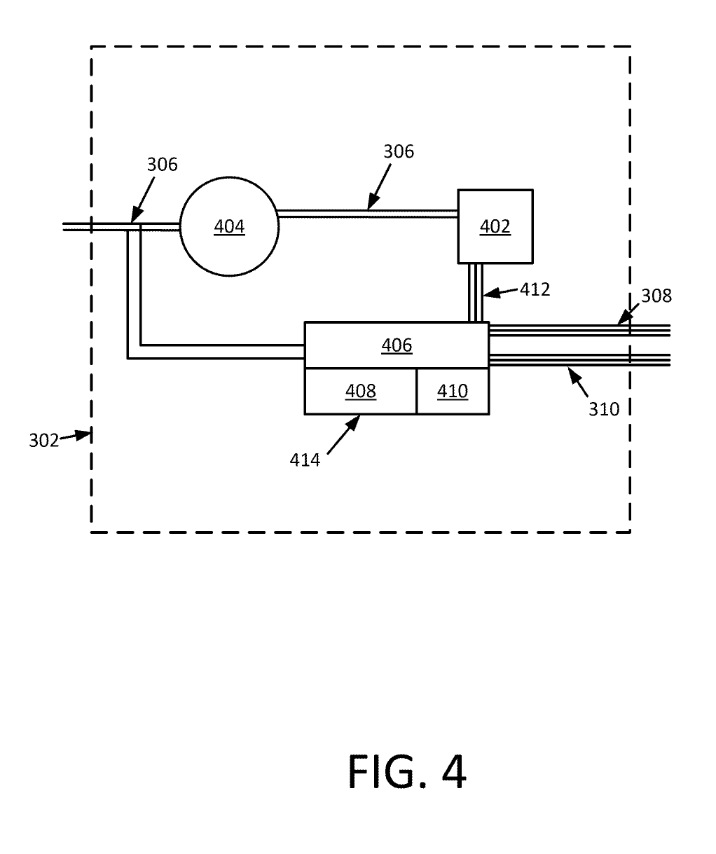

Referring now to FIG. 4, counter circuit 302 may include an ultra-low power counter 402, stored charge device 404, display driver 406, programmable memory 408, and mathematics module 410. In some scenarios, stored charge device 404 may be a battery, a capacitor, or any other device capable of long term charge storage. Counter data bus 412 connects counter 402 with display driver 406, programmable memory 408, and mathematics module 410. Power bus 306 connects the photovoltaic cell (e.g. photovoltaic cell 104 of FIG. 1) with the components of circuit 302. Display bus 308 and reset bus 310 lead to a display (e.g. display 102 of FIG. 1) and a reset switch (e.g. reset switch 312 of FIG. 3), respectively.

The counter 402 can run at any rate, for example by the second. Clock like accuracy is not critical, however. The size of the counter can be user configured according to the need required. For example, the counter may include a minimum of 16 bits. In a scenario, 32 bits or more may be a recommended size to provide a higher level of protection. This document uses a 32 bit counter as an example, however the scenarios described are not limited in this regard. At 1 tic per second a 32 bit counter can run for 100 years without looping to zero.

In a scenario, each circuit 302 is programmed with a serial number, a provider identifying code, a provider routing code, and a master code. Other codes may be used and the scenarios described in this document are not limited in this regard. This information is stored in programmable memory 408 and can be combined with data from the counter 402 to produce a verification code that can be displayed on the face of the card whenever the photovoltaic cell is producing enough current. The verification code can change at configurable intervals. In one scenario, the verification code changes once every minute. Other intervals can be used and the scenarios described in this document are not limited in this regard.

Reset bus 310 provides a power connection between circuit 302 and reset switch 312. Triggering a card reset may cause the counter 402 to restart at a random point and the display 102 to show the current counter reading for a short duration. The duration to display the new counter reading may also be programmable by the provider and/or manufacturer. The reset trigger 312 can be a small button, bare contacts, recessed button or any method that closes the reset circuit. The provider will also log the counter reading showing on the display 102 and log the date and time the reading was taken. Prior to shipping the card to a customer, all information stored on the card for use in producing the verification code is stored with the provider. Table 1 shows information stored on the card in accordance with one scenario. Table 2 shows information that may be stored on the card in accordance with one scenario.

TABLE 1
Values stored on the card.

| Data | Type |
|---|---|
| Counter | 32-Bit |
| CardSerialNumber | 16 digits |
| ProviderNumber1 | 16 digits |
| ProviderNumber2 | 16 digits |
| MasterNumber | 16 digits |
| StaticCode | 4 decimal digits |

TABLE 2
Values stored with card processor.

| Data | Type |
|---|---|
| CounterStartCount | 32-Bit |
| CounterStartTime | Date + Time |
| CardSerialNumber | 16 digits |
| ProviderNumber1 | 16 digits |
| ProviderNumber2 | 16 digits |
| MasterNumber | 16 digits |
| Interval | 16-bits |
| StaticCode | 4 decimal digits |

In reference to Table 1, Counter is an active 32-bit counter as described above, e.g., counter 402. The remainder of the values are stored in programmable memory 408. The CardSerialNumber value is stored in programmable memory 408 and may be printed and bar-coded on a breakaway tab attached to the ID card at time of manufacture. Just prior to a new card being shipped, the provider can log the serial number of the card and destroy the tab. ProviderNumber1 and ProviderNumber2 are numbers which may identify the manufacturer, the provider, the location where the cards were manufactured/activated, a routing number or account number, and the like. MasterNumber may be any number used to identify the card, provider, processor, and the like. Finally, StaticCode is the four (4) decimal code displayed on the card, e.g. static code 106.

The mathematics module 410 generates the verification code by inserting Counter into a mathematical formula along with at least one other value of the card data stored on the ID card. In one scenario, the mathematics module 410 may insert Counter, CardSerial-Number, ProviderNumber1, ProviderNumber2, and MasterNumber into the mathematical formula to generate a decimal long code, which may include any number of digits. The mathematics module then truncates the long code to match the number of digits that are viewable in display 102. In a particular scenario, the mathematics module 410 may truncate the long code so that only the last four digits to the left of any decimal point are displayed in a four digit display 102. In a scenario, the ID card uses a count of the number of display intervals that have passed using the following equation.

IntervalCount=int(ActiveCounter/Interval). (Equation 1)

where, ActiveCounter is the current count read from the counter; and Interval is the display interval, i.e., the amount of time the verification code is displayed on the ID card. In some scenarios Interval may be expressed as a multiple of the counter rate.

Referring to Table 2, although much of the data is the same, the data that is stored by the provider differs slightly. An active counter is not necessary. Any processing entity that is verifying the digital ID card can verify any verification code produced based, in part, on counter 402 as long as the following information is stored. As used in this document, a “processing entity” is an institution or other corporate entity that processes digital ID card transactions. CounterStartCount is a 32-bit number that records the random number at which the counter started when the ID card was activated. The CounterStartTime is a time stamp code that identifies the exact date and time when the counter was started. Finally, Interval is a 16-bit code that represents the verification code display interval. in some scenarios, the interval is some multiple of the counter rate. The processing entity can use CounterStartCount, CounterStartTime, and Interval to accurately predict the current count on the ID card at any point in time using the following equations.

CurrentCounter=((CurrentTime−CounterStartTime))+CounterStartCount (Equation 2)

IntervalCount =int(CurrentCounter/Interval) (Equation 3)

where CurrentTime is a time stamp code for the current date and time;
CurrentCounter is the current counter read out of counter 402′ and

IntervalCount is the current number of intervals that have passed since CounterStartTime.
CardSerialNumber, ProviderNumber1, Provider-Number2, MasterNumber, and StaticCode, are stored by the processing entity exactly as they are stored in the ID card.

To reconstruct the verification number, the processing entity inserts CurrentCounter and at least one other value from the card data to generate the approval code. For example, the processing entity may insert CurrentCounter, CardSerial-Number, ProviderNumber1, ProviderNumber2, and MasterNumber into a mathematical formula, which may be identical to the one used by mathematics module 410 on the ID Card, to generate a decimal long code. Applying the same truncation process as the ID card, the processing entity should produce the same verification code as the ID card.

In some scenarios, as discussed above the counter is started and can be reset at a random number. This provides extra security because it is impossible to predict what number the counter starts at. To limit the starting count so that the counter will have a reasonable life before looping to zero, the random number may have a range. In one scenario, for example, a 32-bit counter may start at any random number in the range of 00000000 to 0000FFFF. As discussed above, the static code may also be randomly generated, although it does not change for the life of the card, until the card is reset. In one scenario, the static code has four decimal digits and is set to a random number in the range of 0000 to 9999.

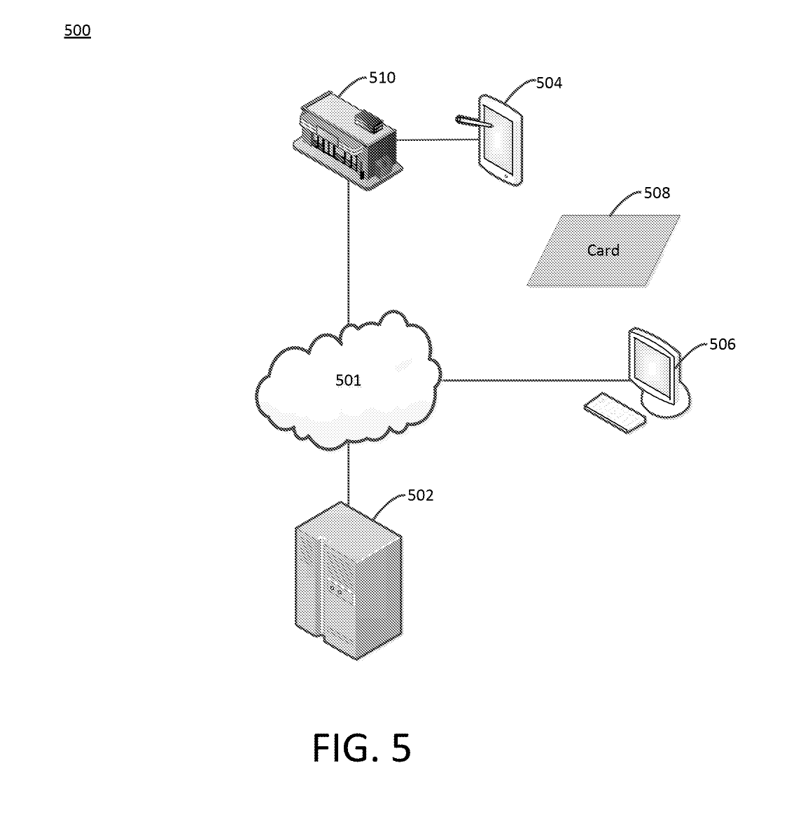

Referring now to FIG. 5, a system 500 is shown implementing a particular scenario. System 500 includes a data network 501 electronically connecting a number of devices. Electronically connected to network 501 is server device 502, provider device 506, and merchant 510. Merchant 510 also includes point-of-sale device 504. A consumer may present ID card 508, which may be similar to digital ID card 100, for payment of an amount owed to merchant 510. As described above, card 508 includes card data, such as the data shown above in Table 1, which is used to generate a verification code which is displayed on the front of card 508. Server device 502 also has the card data, similar to that shown above in Table 2, which is used to verify the verification code. Provider device 506 may also have access to the card data and may be used to verify a verification code from card 508. Additionally, in the event that card 508 needs to be reset, a provider may request a readout of the new counter start count and counter start time to enter into server device 502 for future transactions.

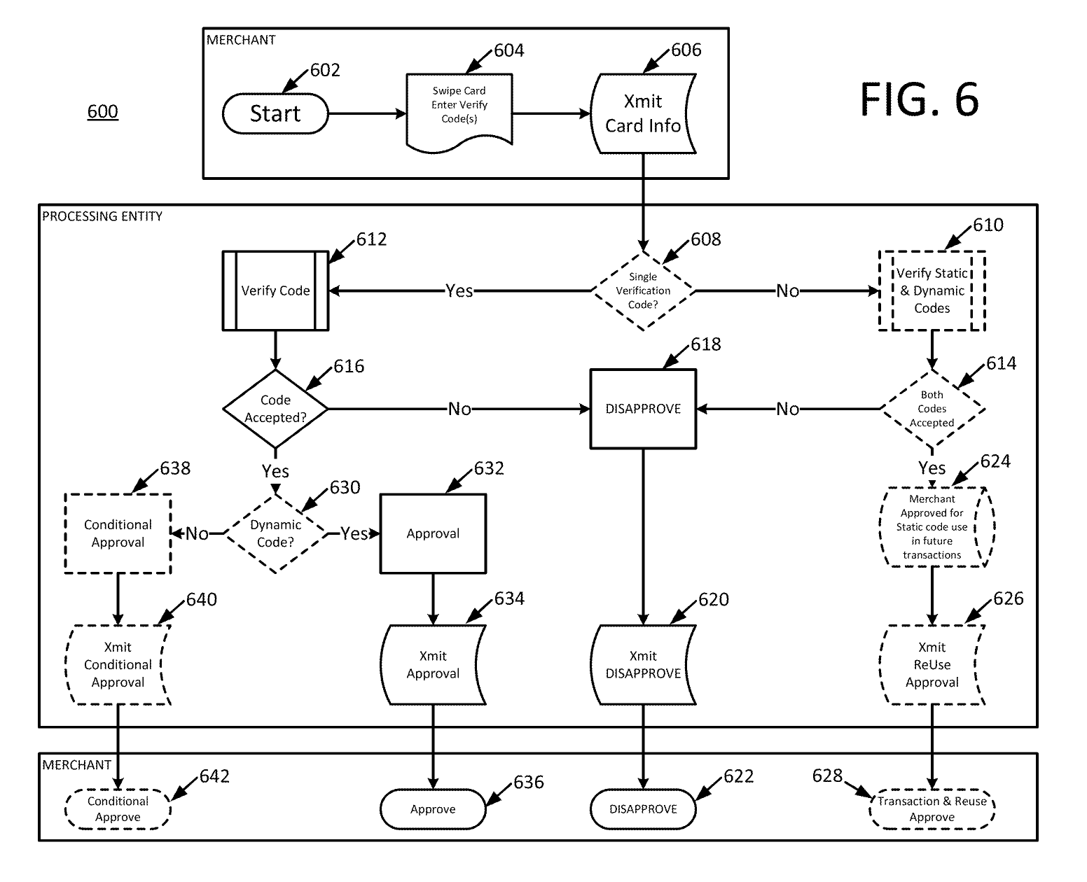

Referring now to FIG. 6, a flow chart is provided that shows a scenario for processing the verification code. Although FIG. 6 is shown in reference to a financial transaction, it will be apparent to one of ordinary skill that various parts of the process shown can be used in a variety of other types of transactions. The implementations described in this document are not limited in this regard. In the scenario shown in FIG. 6, process 600 begins at a merchant with a transaction requiring verification of the verification code 602. At a point-of-sale the user or merchant swipes the card or otherwise presents the card to a card reader for reading encoded data, and the user or merchant enters the verification code. The verification code, and other information detailing the intended transaction are transmitted to a processing entity which processes the transaction 606. The processing entity may be a bank, clearing house, credit card processor, or other company or institution that processes transactions.

At the processing entity, process 600 goes through a series of decision steps to determine whether to approve, conditionally approve, or disapprove (i.e. deny) the transaction. One of skill in the art will note that not all of the steps described in process 600 are required. For example, in the simplest decision process, only a single verification code (i.e. a dynamic verification code) is provided by the merchant. In this simple example, the information transmitted from the merchant is received by the processing entity which proceeds directly to verify the dynamic verification code 612. If the code is accepted (616: Yes) the transaction is approved 632, and the approval is transmitted to the merchant 634. After receiving the approval, the merchant completes the transaction 636. If, on the other hand, the code is not accepted after verification (616: No), the transaction is disapproved 618. The disapproval is transmitted to the merchant 620, and the merchant does not complete the transaction 622. In some implementations, the verification code is only accepted during the interval in which it is displayed. In other implementations, the verification code may be accepted one or more intervals before and/or one or more intervals after the current interval during which the displayed verification code is calculated.

In more robust examples, process 600 may optionally determine whether additional and/or static codes are provided. As described above in reference to FIG. 1, static code 106 may be included on the card, either on the front or the back. In one scenario, the transmission from the merchant only includes a single, dynamic code (608: Yes), process 600 proceeds in similar fashion to the simple example described above. The code is first verified 612. If the code is accepted (616: Yes) and is a dynamic code (630: Yes), the transaction is approved 632. Approval is transmitted to the merchant 634, and the merchant completes the transaction 636. Again, if the code is not accepted (616: No) the transaction is disapproved 618, disapproval is transmitted to the merchant 620, and the merchant cannot complete the transaction 622.

In another scenario, only a single, static code is provided (608: Yes), and the code is verified 612. If the code is accepted, process 600 determines whether the code is a static or dynamic code 630. Since the code is a static code (630: No), the transaction is conditionally approved 638. The conditional approval is transmitted to the merchant 640, and the merchant completes the transaction 642. From the perspective of the merchant or the purchaser, a conditional approval may be identical to an approval. Conditional approval, however, allows the processing entity to flag the transaction and/or card for the purposes of fraud and loss prevention. If, the code is not accepted (616: No), the disapproval process proceeds as previously described.

In yet another scenario, both the dynamic and the static codes are provided (608: No). Both the static and dynamic codes are verified 610. If both codes are accepted (614: Yes), the transaction is approved 624, and the approval is transmitted to the merchant 626. The merchant then completes the transaction 628. Optionally, the merchant may be approved for static code use in future transactions 624. Such static code approval is transmitted with the transaction approval 626, and the merchant point-of-sale is then updated to allow for static code verification. Static code approval may allow the merchant flexibility to provide fast transaction services to trusted and/or regular customers. The initial double verification process, however, provides additional security to the transaction. If both codes are not accepted (i.e. one or both of the codes are not verified) (614: No), the transaction is disapproved 618, and the disapproval process proceeds as described above.

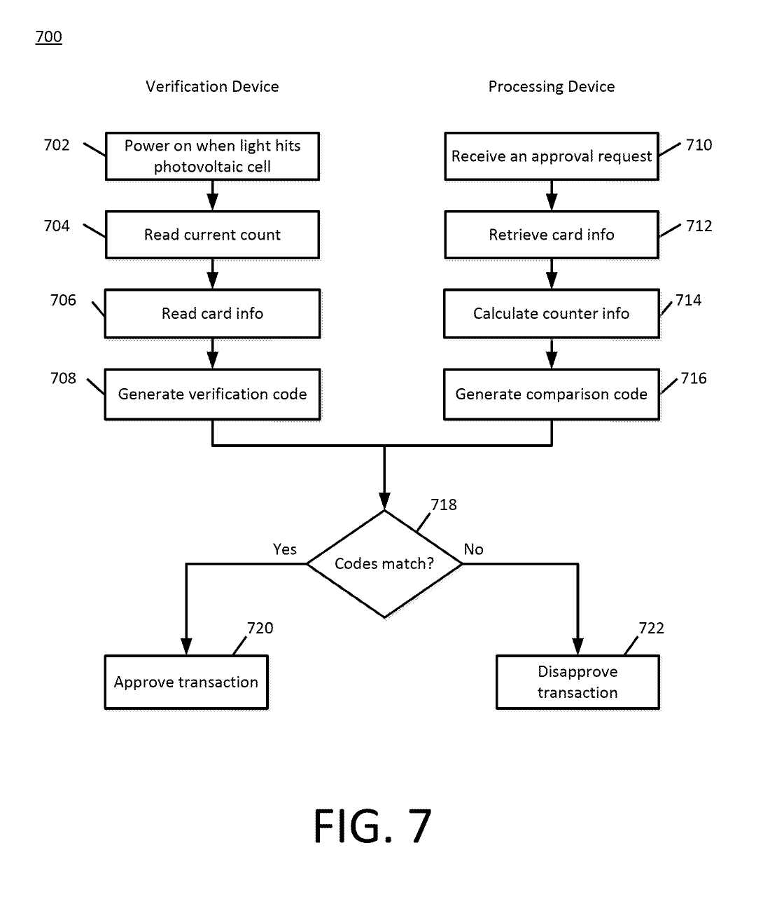

Referring now to FIG. 7, a flow chart is provided showing process 700 for verifying the verification code in accordance with a scenario. The first portion of process 700 is split between a processing device, i.e. a server at a processing entity that processes digital ID card transactions, and a verification device, i.e. the digital ID card. For example, part of process 700 that includes steps 702-708 may be performed on ID card 100 of FIGS. 1-3 or ID card 508 of FIG. 5. Conversely, part of process 700 that includes steps 710-716 may be performed on server 502 and/or provider device 506 of FIG. 5. Part of process 700 that includes steps 718-722 may be performed on a processing device and/or a point-of-sale device.

At the verification device, process 700 beings with light activating a photovoltaic cell of a digital ID card 702, i.e. photovoltaic cell 104 of FIG. 1. As explained above, the photovoltaic cell not only replenishes the source charge that powers the counter, but also provides the only power to the other components of the digital ID card. With power restored to the verification components, the mathematics module reads the current count from the counter 704. The mathematics module also reads the card data stored in the programmable memory 706. With all information collected, the mathematics module generates the verification code 708. The verification code is generated by inserting the current count and at least one value from the card data into a mathematical formula. Since the result may be a number with many digits, the mathematics module truncates a resulting long code to the four digit authorization code, in the example of a four digit display as shown in FIG. 1.

At the processing device, the process 700 continues with the processing device receiving an approval request 710. The approval request may include the verification code or may include a unique identifier from the card data, for example a card serial number. The processing device retrieves card data from a database 712. The processing device uses the card info to calculate the current count 714. Using the retrieved card data and the calculated current count, the processing device generates a comparison code 716. The comparison code is generated in a similar manner as that of the verification code discussed above with reference to step 708.

The verification and comparison codes are compared to determine if they match 718. If they do (718: Yes), the transaction is approved. If they do not match (718: No), the transaction is disapproved. As mentioned above, this last portion of process 700 may be performed by the processing device or by a point-of-sale device. In one scenario, for example, the verification code may be transmitted to the processing device along with all other payment info. In this scenario the processing device may perform the comparison. In another scenario, an identifier, such as the card serial number, may be transmitted to the processing device. This way, the processing device only produces the comparison code, and transmits this back to the point-of-sale device. In this scenario, the point-of-sale device performs the comparison.

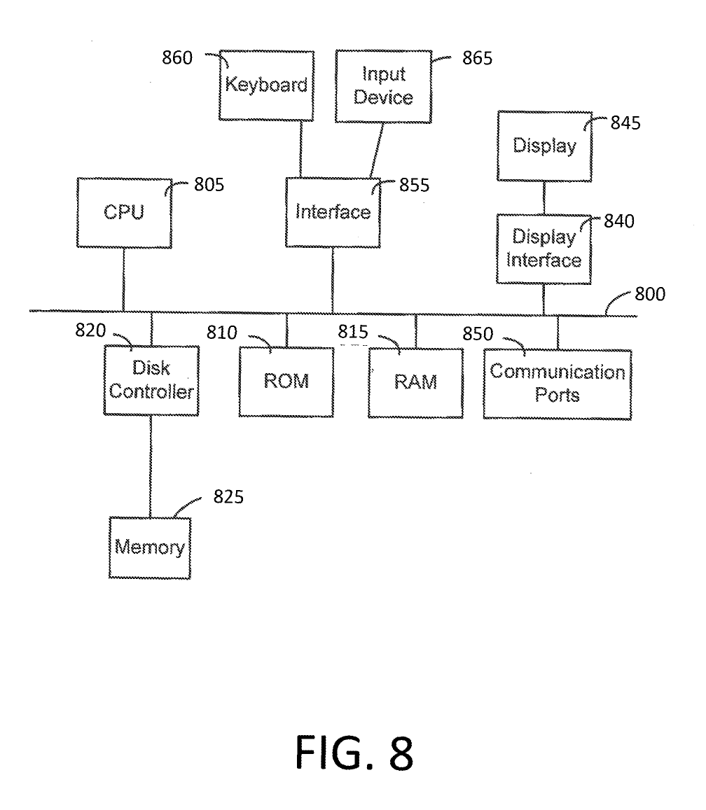

FIG. 8 depicts a block diagram of internal hardware that may be used to contain or implement the process discussed above. A bus 800 serves as the main information highway interconnecting the other illustrated components of the hardware. CPU 805 is a processor, the central processing unit of the system that performs calculations and logic operations required to execute a program. CPU 805, alone or in conjunction with one or more of the other elements disclosed in FIG. 8, is a processing device, computing device or processor as such terms are used within this disclosure. Read only memory (ROM) 810 and random access memory (RAM) 815 constitute examples of memory devices.

A controller 820 provides an interface between with one or more optional tangible, computer-readable memory devices 825 and the system bus 800. These memory devices 825 may include, for example, an external or internal DVD or CD ROM drive, a hard drive, flash memory, a USB drive or the like. As indicated previously, these various drives and controllers are optional devices. Additionally, the memory devices 825 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the methods and systems as discussed in this document may be stored in the ROM 810 and/or the RAM 815. Optionally, the program instructions may be stored on a tangible computer readable medium such as a compact disk, a digital disk, flash memory, a memory card, a USB drive, an optical disc storage medium, such as a Blu-rayTM disc, and/or other recording medium.

An optional display interface 840 may permit information from the bus 800 to be displayed on the display 845 in audio, visual, graphic or alphanumeric format. The display 845 may be an emissive display viewable by directly perceiving the light emitted from the display. Alternatively, the display may be a reflective display viewable by perceiving light reflected off the surface of the display. Communication with external devices may occur using various communication ports 850. A communication port 850 may be attached to a communications network, such as the Internet or a local area network.

The hardware may also include an interface 855 which allows for receipt of data from input devices such as a keyboard 860 or other input device 865 such as a mouse, a joystick, a touch screen, a remote control, a pointing device, a video input device and/or an audio input device.

Because the provider has all the information stored in the ID card, it is able to predict the number currently showing on any card at the time an ID is requested. Since ID verification may occur at the end of an interval, to prevent a rejection the provider may choose to accept the current and one or more previous and/or one or more future ID codes, leaving an approval window that is larger than the programmed interval length. Additionally or alternatively, the ID card may be programmed to provide an indication within a predetermined short period of time prior to the number showing on the card being changed. For example, the number displayed on the card may flash on and off for two minutes before changing, so that the user has ample warning that the number change is imminent. Based on this indication, the user may elect to delay using the card for a small amount of time until the number change is executed.

The present embodiments may be effective to thwart an attempt to hack or reverse engineer the digital ID card to reproduce the verification code on other media, since that effort would only work for one card and would not compromise the system as a whole. If a single card is compromised, once the fraud is discovered the ID card can be reset and the new counter reading can be re-synchronized with the provider. The provider would identify the person re-syncing the digital ID card through personal information they have on file. Resetting the card would immediately change the characteristics of the ID code, canceling the efforts of a hack. Thus, there is no need to reissue an ID card.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the following claims.

1. A transaction card comprising:
a verification code display;
a photovoltaic cell; and
an integrated circuit comprising:
a stored charge device configured to be replenished by the photovoltaic cell;
a multi-bit counter configured to count the passage of defined intervals of time, the counter powered from the source charge;
a programmable memory for storing a plurality of codes
a mathematics module configured to execute programming instructions to generate a verification code based on a current count from the counter and at least one of the plurality of codes stored in the programmable memory; and
a display driver electrically coupled with the display, the display driver configured to cause the verification code to be output to the display,
wherein the programmable memory, mathematics module, display driver, and display are powered from the photovoltaic cell.

2. The transaction card according to claim 1, wherein the multi-bit counter is started at a first randomly generated start count.

3. The transaction card according to claim 2 further comprising a reset switch configured to cause the counter to reset to a second randomly generated number.

4. The transaction card according to claim 3 further comprising a static code.

5. The transaction card according to claim 4, wherein the static code is printed on or formed into the device.

6. The transaction card according to claim 4 further comprising a second display, wherein the static code is displayed on the second display.

7. The transaction card according to claim 6, wherein the static code is a randomly generated number.

8. The transaction card according to claim 7, wherein the static code is randomly generated when the device is first activated.

9. The transaction card according to claim 7, wherein the static code is randomly generated when the device is reset with the reset switch.

10. A system for verifying a transaction, the system comprising:
a verification device comprising:
a counter configured to count the passage of defined intervals of time, wherein the first counter is started at a randomly generated start count; and
a first circuit configured to generate a verification code based in part on a current count of the first counter;
a processing device comprising:
a second circuit configured to electronically receive and verify the verification code based, in part, on the current count, wherein the second circuit calculates the current count independently of the counter.

11. The system according to claim 10, wherein the verification device further comprises a first programmable memory, and wherein the first circuit generates the verification code by:
retrieving a current count from the first counter;
retrieving card data stored in the programmable memory;
inserting the current count and at least a portion of the card data into a mathematical formula to produce a first long code; and
truncating the first long code to a limited number of digits to be the verification code.

12. The system according to claim 11, wherein the processing device further comprises a second programmable memory, and wherein the second circuit verifies the verification code by:
retrieve card data stored in the second programmable memory;
determine a current count based on the card data;
inserting the current count and at least a portion of the card data into a mathematical formula to produce a second long code;
truncating the second long code to a limited number of digits to be a comparison code; and
comparing the verification code and the comparison code.

13. The system according to claim 12, wherein the second circuit is further configured to:
on a condition that the verification code and the comparison code match, approve the transaction; and
on a condition that the verification code and the comparison code do not match, disapprove the transaction.

14. The system according to claim 13, wherein the verification code includes a dynamic code and a static code and the second circuit is further configured to:
verify both the static and the dynamic codes;
on a condition that either the static or the dynamic code is not verified, disapprove the transaction; and
on a condition that both the static and the dynamic code are verified, approve the transaction.

15. A method for verifying a transaction, the method comprising:
receiving a verification code generated based in part on a current count from a counter configured to count the passage of defined intervals of time, wherein the counter is started at a randomly generated start count;
verifying the verification code based in part on a current count calculated independently from the counter; and
on a condition the verification code is verified, transmitting approval for the transaction.

16. The method according to claim 15, wherein verifying the verification code comprises:
retrieving card data stored in a programmable memory;
determine the current count based on the card data;
inserting the current count and at least a portion of the card data into a mathematical formula to produce a second long code;
truncating the second long code to a limited number of digits to be a comparison code; and
comparing the verification code and the comparison code.

17. The method according to claim 15, further comprising
on a condition that the verification code and the comparison code match, transmitting approval of the transaction; and
on a condition that the verification code and the comparison code do not match, transmitting disapproval of the transaction.

18. The method according to claim 15
on a condition that the verification code is a static code, transmitting conditional approval of the transaction; and
on a condition that the verification code is a dynamic code, transmitting, transmitting approval the transaction without condition.

19. The method according to claim 15, wherein the verification code includes a dynamic code and a static code, the method further comprising:
verifying both the static and the dynamic codes;
on a condition that either the static or the dynamic code is not verified, transmitting disapproval the transaction; and
on a condition that both the static and the dynamic code are verified, transmitting approval the transaction.

20. The method according to claim 19, wherein both the static and dynamic codes are verified and the method further comprises transmitting approval for future use of only the static code to verify transactions.
